(19) United States
(12) Patent Application Publication
(10) Pub. No.: US 2024/0412214 A1
(43) Pub. Date: Dec. 12, 2024

(54) SYSTEMS AND METHODS FOR TRANSACTION PROCESSING BASED ON USER AUTHENTICATION

(71) Applicant: Capital One Services, LLC, McLean, VA (US)

(72) Inventors: Jeffrey RULE, Chevy Chase, MD (US); Kevin OSBORN, Newton Highlands, MA (US)

(21) Appl. No.: 18/207,941

(22) Filed: Jun. 9, 2023

(51) Int. Cl. G06Q 20/40; G06Q 20/38

(52) U.S. Cl. CPC G06Q 20/4014; G06Q 20/3829; G06Q 20/4018

(57) ABSTRACT

The present embodiments include a system and method for securely completing a checkout process associated with a consumer transaction. The system can include a card and a software application. The software can authenticate the user with card information, then retrieve checkout data associated with the user. The application can complete the checkout process automatically rather than be manually completed by the user.

### FIELD OF THE DISCLOSURE

The present disclosure relates to systems and methods for transaction processing based on user authentication.

### BACKGROUND

Online consumer transactions often conclude with a checkout process. This checkout process often requires the user to input identifying information, payment information, and shipping information. Even still, checkout may require the user to create an account before completing the transaction. This conventional process is time-consuming, annoying, and not secure. Typing in several fields of information can be tedious for the user, even with auto-populating features. This not only takes time but can lead to some fields being filled with inaccurate checkout information such as a mistyped address. Mistakes like these can frustrate the user and make the checkout process abrasive.

Additionally, the checkout process is often insecure. Conventional checkout processes often require only credit card information as the only authentication. If a thief has stolen a user's card, they can pass through this authentication step with ease.

These and other deficiencies exist. Therefore, there is a need to provide a system and method that overcome these deficiencies.

### SUMMARY OF THE DISCLOSURE

Embodiments of the present disclosure provide a system for securely fulfilling a checkout information request on a mobile application, the system comprising a software application. The software application comprises instructions for execution on a user device. Furthermore, the software application configured to receive, over a network, a checkout request and open, in response to receiving the checkout request, a communication field. Then, the software application can receive a payload from the card via the communication field, the payload further comprising encrypted user identification data and a first authentication credential. Next, the software application can decrypt the encrypted user identification data and match, upon decrypting the encrypted user identification data, the decrypted user identification data with a user account. Then, the software application can retrieve, upon matching the decrypted user identification data with the user account, checkout data, wherein the checkout data can satisfy the checkout request.

Embodiments of the present disclosure provide a method for securely fulfilling a checkout information request on a software application comprising instructions for execution on a user device. The method comprising the following steps: The software application can receive, over a network, a checkout request and open, in response to receiving the checkout request, a communication field. Then, the method proceeds with receiving, by a software application, a payload from a card, via the communication field, the payload further comprising encrypted user identification data and a first authentication credential. Next, the method proceeds with decrypting, by the software application, the encrypted user identification data and matching, upon decrypted the encrypted user identification data, the decrypted user identification data with a user account. Lastly, the method proceeds with retrieving, upon matching the decrypted user identification data with the user account, checkout data, wherein the checkout data can satisfy the checkout request.

Embodiments of the present disclosure provide a computer readable non-transitory medium comprising computer executable instructions that, when executed on a processor, configure the processor to perform procedures comprising the steps of: receiving a checkout request and opening, in response to receiving the checkout request, a communication field. Next, processor proceeds with receiving at least a payload from a card wherein the card has entered the communication field, the payload further comprising at least one or more encrypted user identification data and at least a first authentication credential. Next, the processor proceeds with decrypting the encrypted user identification data and matching the decrypted user identification data with an existing user account. Next, the processor proceeds with retrieving, upon matching the decrypted user identification data with an existing user account, checkout data, wherein the checkout data can satisfy the checkout request.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1 is a block diagram illustrating a system according to an exemplary embodiment.

FIG. 2 is a block diagram illustrating a card according to an exemplary embodiment.

FIG. 3 is a diagram illustrating a contact pad according to an exemplary embodiment.

FIG. 4 is a flowchart illustrating a process according to an exemplary embodiment.

FIG. 5 is a diagram illustrating a communication field according to an exemplary embodiment.

FIG. 6 is a flowchart illustrating a process according to an exemplary embodiment.

FIG. 7 is a flowchart illustrating a process according to an exemplary embodiment.

FIG. 8 is a flowchart illustrating a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present embodiments relate generally to a checkout process made easier and safer with use of a contactless card. When a user is ready to conclude their consumer experience—for example, they are ready to check out their cart on a mobile shopping application-they can tap their contactless card to their user device in order to interact with a software application. The contactless card transmits an authentication credential to the mobile application. The mobile application checks the credential and matches it with a user on file. Based on the user on file, the application retrieves the data necessary to perform the checkout, such as card information, personal identity information, and shipping information.

These embodiments present a number of advantages over conventional methods. For example, these methods provide a much faster way to complete a transaction on a mobile shopping application. Rather than force the user to type in their checkout information or otherwise auto-populate the information incorrectly, the user can simply tap their contactless card and allow the mobile application itself to fill in the necessary information. Thus, the user saves time and frustration.

Furthermore, the present embodiments offer a much safer way to perform checkout. The communication field ensures that the authentication credentials and transmitted to the merchant over a very small distance and over a short amount of time. This reduces the risk of an interfering third party from intercepting the credential or other personal information. Furthermore, the server itself retrieves the checkout data after matching the personal information with a user on file. Thus, the checkout data itself is kept only within the server.

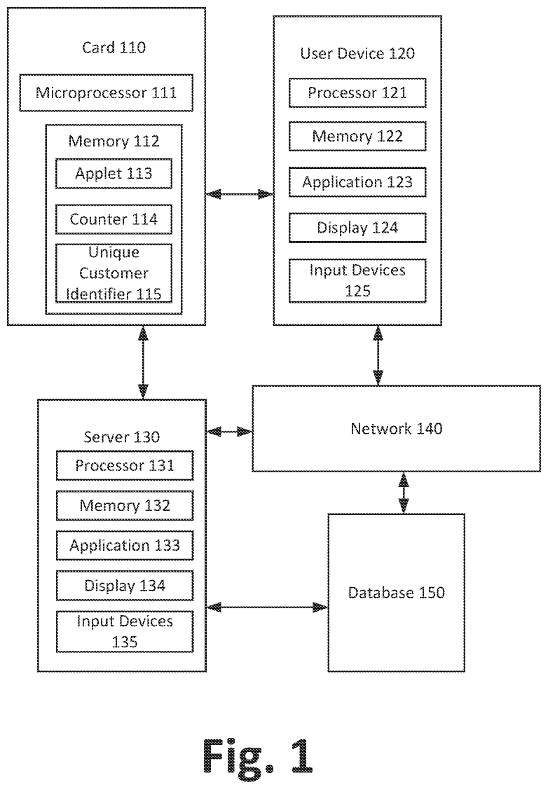

FIG. 1 is a block diagram illustrating a system according to an exemplary embodiment.

FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

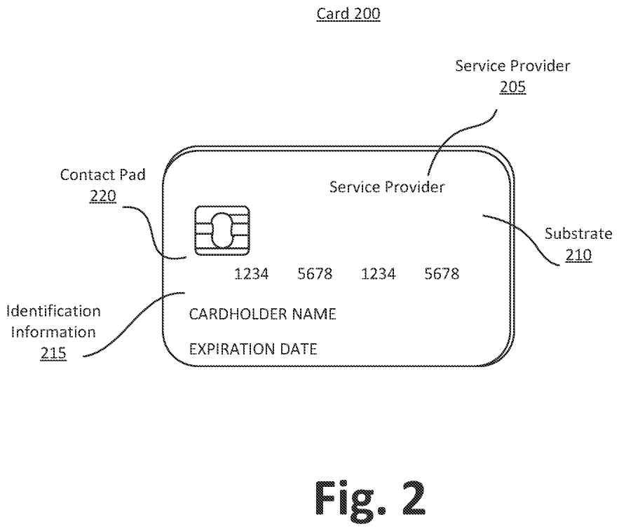

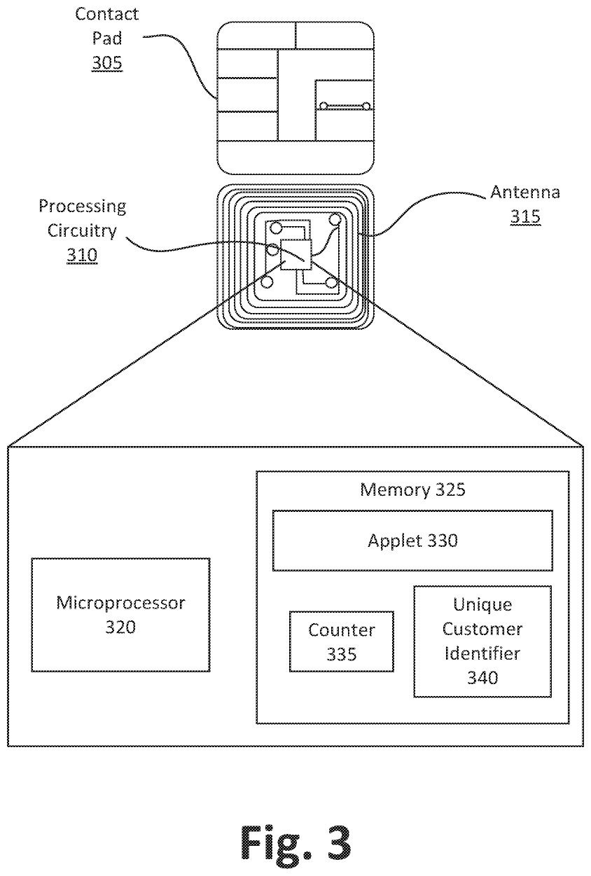

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, to transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touchscreen, keyboard, mouse, cursor-control device, touchscreen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the card 110, retaining a web session between the user device 120 and the card 110, and masking private data received from the user device 120 and the card 110. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touchscreen, keyboard, mouse, cursor-control device, touchscreen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network and may be configured to connect the user device 120, the server 130, the database 150 and the card 110. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the card 110, the user device 120, the server 130, the network 140, and/or the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition, or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card. The card can be associated with a spending account, savings account, investment account, a hybrid account, a credit account, or any other financial account.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the 3ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2 and FIG. 3. These components may be located behind the contact pad 220 or elsewhere on the substrate 210. The contactless card 200 may also include a magnetic strip or tape, which may be located on the back of the card (not shown in FIG. 2).

FIG. 3 illustrates a contact pad 305 of a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet, and perform the functions described herein. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NFC Data Exchange Format (NDEF) message that comprises a cryptographically secure OTP encoded as an NDEF text tag.

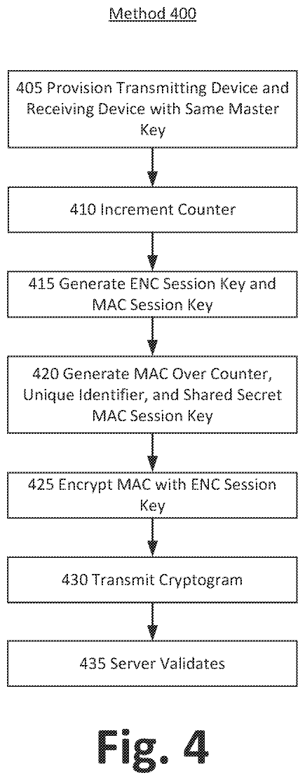

FIG. 4 is a flow chart of method 400 of key diversification according to an example of the present disclosure.

In some examples, a sender and recipient may desire to exchange data via a transmitting device and a receiving device. In some embodiments, the transmitting device is the contactless card, and the receiving device is the server. In other embodiments, the receiving device may comprise a user device. In other embodiments, the transmitting and the receiving device are network-enabled computer devices as described herein. It is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device. The transmitting device and the receiving device may be configured to communicate via NFC, Bluetooth, RFID, Wi-Fi, and/or the like.

The method 400 can begin with step 405. In step 405, a transmitting device and receiving device may be provisioned with the same master key, such as the same master symmetric key. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 410, the transmitting device may take the selected cryptographic algorithm, and using the master symmetric key, process the counter value. For example, the sender may select a symmetric encryption algorithm, and use a counter which updates with every conversation between the transmitting device and the receiving device. The one or more counters may comprise a numeric counter sufficient to store an integer. The transmitting device may increment the counter one or more times.

In step 415, the transmitting device generates two session keys: one ENC (encryption) session key and one MAC (message authentication code) session key. The transmitting device may encrypt the counter value with the selected symmetric encryption algorithm using the master symmetric key to create a session key.

In step 420, the transmitting device generates the MAC over the counter, the unique customer identifier, and the shared secret MAC session key. The customer identifier may comprise a unique alphanumeric identifier assigned to a user of the contactless card, and the identifier may distinguish the user of the contactless card from other contactless card users. In some examples, the customer identifier may identify both a customer and an account assigned to that customer and may further identify the contactless card associated with the customer's account.

In step 425, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 430, the transmitting device transmits a cryptogram to the receiving device. The cryptogram can include the applet information, the unique customer identifier, the counter value, and the encrypted MAC. In step 435, the receiving device validates the cryptogram. For example, the receiving device generates its own UDKs (unique diversified keys) using the unique customer identifier 340 and the master key. The unique customer identifier is derived from the validated cryptogram. Recall that the receiving device has already been provisioned with the master key. The receiving device generates two session keys: one ENC (encryption) session key and one MAC (message authentication code) session key. The receiving device may generate these session keys from the UDKs and the counter value. The counter value can be derived from the cryptogram. The receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key. The receiving device validates the MAC with the MAC session key generated in step 515. The receiving device may validate the MAC over the unique customer identifier and the counter value.

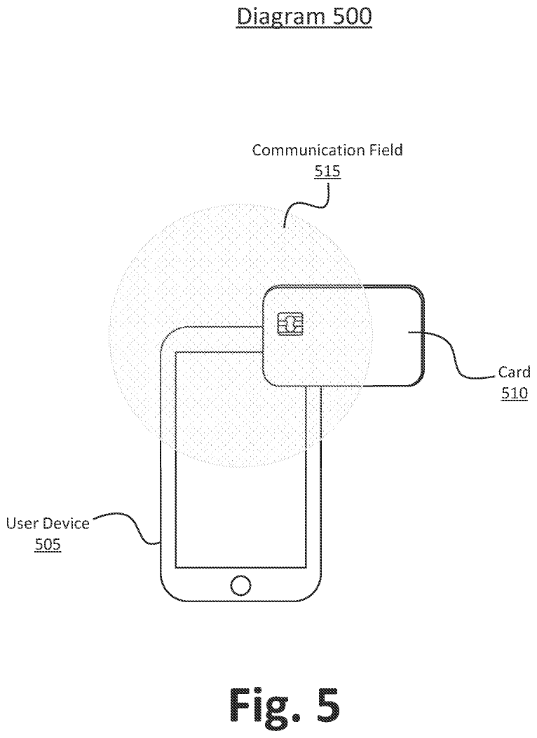

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g., a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the card are in close contact with each other so that they can exchange information within the communication field.

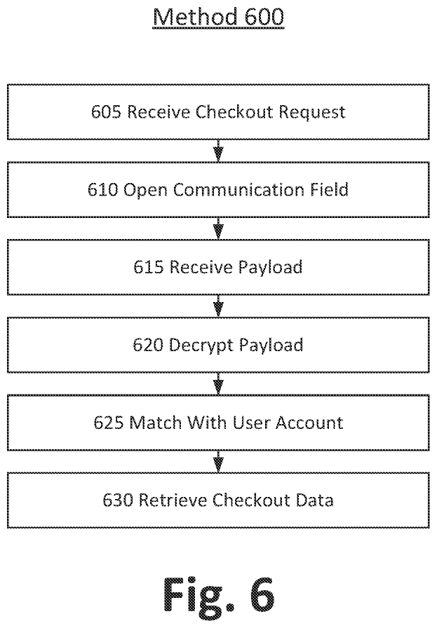

FIG. 6 is a method flowchart illustrating a flowchart according to an exemplary embodiment. The process can include without limitation a contactless card, a mobile application or some other software application, a server, and a network. Generally, a mobile application is application that run on a mobile device or computer-enabled mobile device including without limitation a smartphone, tablet, or smart watch. The mobile applicable can be accessible via a user device discussed with further reference to FIG. 1. In some embodiments, the mobile application can comprise a software development kit (SDK) configured to receive and transmit information over a communication field. In other embodiments, a web application can be used in place of a mobile application. In other embodiments, the software application is associated with a merchant mobile application or merchant software application configured to perform one or more mobile transactions. A merchant mobile application or merchant software application is a software application associated with one or more merchants and accessible through a computer-enabled device. A mobile transaction can include without limitation transaction of information from a mobile device to some other mobile device, computer-enabled device, or some other device.

In action 605, a checkout request or checkout information request can be received. The checkout request can be received by the mobile application from a server over a network. In other embodiments, the checkout request can be transmitted by the contactless card to the mobile application over a communication field, card reader, or wireless network. In other embodiments, the checkout request can be transmitted by user via the user device to the mobile application over a network. As a nonlimiting example, a user can transmit a checkout request to a mobile application at the conclusion of their shopping experience. In other embodiments, the checkout request can be associated with an experience or activity including but not limited to a dining experience, a theatrical production, a motion picture experience, a concert experience, a theme park, an art exhibition, a museum experience, a shopping experience, a housing tour, a transit experience such as a hotel stay, a flight, bus trip, train trip, or boat trip, any purchase or rental of equipment, a beauty experience such as a haircut, massage, facial, pedicure, manicure, a sporting event experience, such as a baseball game, a football game, a basketball game, or a hockey game, or any other consumer experience.

In action 610, the mobile application can open a communication field. Communication fields are discussed with further reference to FIG. 5. The communication field can be opened via a user device, including without limitation a network-enabled computer device, personal computer, and other devices discussed with reference to FIG. 1. In other embodiments, the communication field can be opened by the mobile application executing on the user device and/or another. The communication field can be at least a near field communication (NFC) field, a Bluetooth field, or a radio-frequency identification (RFID) field. In other embodiments, more than one communication field may be opened.

Upon opening the communication field, in action 615 the mobile application can receive a payload from the contactless card. As a nonlimiting example, the user can place the contactless card within the communication field and transmit the payload. The payload can comprise encrypted user data. The user data can include user identification data including without limitation encrypted personal identifying information such as a name, email, phone number, address, and other identifying information. Furthermore, the encrypted user data or encrypted user identification data can include without limitation contactless card information, account information, a unique customer identifier, a counter, and some combination thereof. The user data or datum can be encrypted using a hash such as SHA-256 or any similar hash function. The encrypted nature of the user data coupled with the close proximity of the communication field improves the security of the transaction. Additionally, the payload can include one or more private keys necessary to decrypt the payload. Exemplary diversified key exchanges are discussed with further reference to FIG. 4, however, it is understood that the present application is not limited thereto.

In action 620, the payload can be decrypted. This action can be performed by the mobile application. In other embodiments, the mobile application can transmit the payload to a server where the payload can be decrypted. The payload can be decrypted by a private key sent along with the payload, or by some other shared key. In some embodiments, the mobile application or software application can transmit the decrypted payload or decrypted user identification data to a server, then the server can match the decrypted user identification data with a user account comprising at least checkout data, then the server can transmit the checkout data to the mobile application or software application.

In action 625, the decrypted user data can be matched with a user account on file. This action can be performed by the mobile application or server. In some embodiments, the mobile application can match the user data with a user account on file, at which point in action 630 the mobile application or server can retrieve the checkout data, thus satisfying the checkout request. The checkout data can be retrieved from a database or data storage unit associated with the mobile application or server. If retrieved by the server, the server will transmit the checkout data to the mobile application. Once in possession of the checkout data, the mobile application will complete or populate the information fields necessary for completing the consumer transaction. The checkout data can include without limitation a card number, a card verification value (CVV), and card expiration date. The data can further include without limitation a shipping address, name, and account number associated with the mobile application.

In some embodiments, the mobile application can, upon matching the decrypted user information with a user on file, provide a virtual card number (VCN) or temporary virtual card for the purpose of completing the transaction. Virtual payment cards are unique payment cards that allow users to complete transactions on their main payment card account associated with one or more of their financial accounts without using the assigned numbers associated with these accounts. In some examples, virtual payments cards can be limited to one-time use. In other examples, virtual payment cards can be limited to a predetermined number of uses and/or an unlimited number of uses over a predetermined time period. In other examples, the virtual payment cards can be limited to use with designated merchants, such as individual merchants, individual merchants a particular locations, or groups of multiple merchants.

It is understood that virtual payment cards can have other characteristics and features as described herein. The virtual payment card may be available on a third-party mobile application or web application. The virtual payment card may be sent via short message service (SMS) or multi-media service (MMS) messaging from an account processing system. The virtual card may contain the information present on a physical contactless card discussed in FIG. 2 and FIG. 3. The virtual payment card may expire after a certain amount of time, for example fifteen minutes. It is understood that the amount of time can be lengthened or shortened greatly.

The virtual payment card may expire if the user device leaves a predetermined geographical area. For example, the virtual payment card may be limited to a specific shopping mall or store. The area can be bounded electronically such that when the user device or card leaves the bounded area, the virtual payment card will expire. This predetermined area can be decided by the administrator processing system, the account processing system, or the users themselves. The geographical area can vary considerably. For example, the virtual card may be limited to a small area around a particular storefront. The virtual payment card may be limited by vendor to only one or more vendors. For example, a card may be limited to only one unique vendor in a unique location. Further, the virtual card may be limited to vendors in a designated area such as a mall, market, or flea market. In another example, the virtual card may be limited to an entire franchise
that is, the card may be used at any store that is associated with a specific franchise.

Additionally, the virtual payment card may be limited by the amount of money available on the card. The card may be capped at a certain amount, for example $100. This amount can vary considerably. This amount can be determined by the user, the administrator processing system, or the account processing system. It is understood that a virtual payment card may combine these one or more limitations. Later, the virtual payment card can be used to perform a checkout at the conclusion of the user's reservation. As another example, the limitation on the amount of money available may be based on whether the user is inside or outside of a predetermined geographical area (e.g., a higher amount is available inside the geographical area than outside the geographical area) or one or more particular vendors (e.g., a higher amount is available to particular designated vendors than to other vendors).

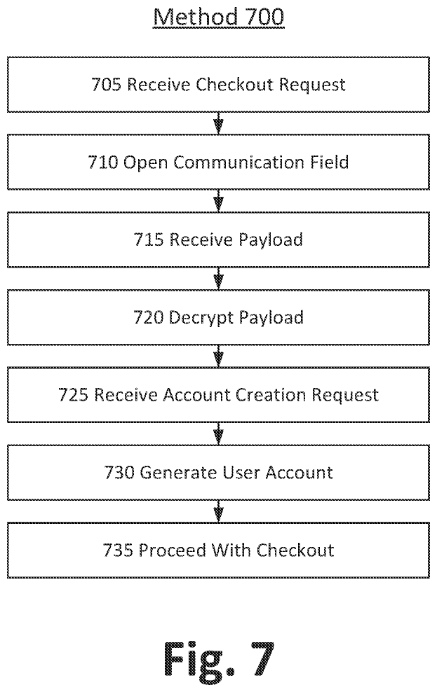

FIG. 7 is a method flowchart illustrating a process according to an exemplary embodiment. The method 700 illustrates how the mobile application can create a user account during the checkout process or the checkout information request fulfillment process. By retrieving the user's information, the mobile application can quickly create a user account associated with the transaction, thus saving time and frustration. In other embodiments, a web application can be used in place of a mobile application. In other embodiments, the software application is associated with a merchant mobile application or merchant software application configured to perform one or more mobile transactions. A merchant mobile application or merchant software application is a software application associated with one or more merchants and accessible through a computer-enabled device. A mobile transaction can include without limitation transaction of information from a mobile device to some other mobile device, computer-enabled device, or some other device.

In action 705, the mobile application can receive a checkout request. The mobile application can be associated with a merchant or other provider of a consumer product, service, or experience. The checkout request can be received by the mobile application from a server over a network. In other embodiments, the checkout request can be transmitted by the contactless card to the mobile application over a communication field, card reader, or wireless network. In other embodiments, the checkout request can be transmitted by user via the user device to the mobile application over a network. As a nonlimiting example, a user can transmit a checkout request to a mobile application at the conclusion of their shopping experience.

In action 710, the mobile application can open a communication field. Communication fields are discussed with further reference to FIG. 5. The communication field can be opened via a user device, including without limitation a computer-enabled mobile device, personal computer, and other devices discussed with reference to FIG. 1. The communication field comprises at least a near field communication (NFC) field, a Bluetooth field, or a radio-frequency identification (RFID) field. In other embodiments, more than one communication field may be opened. For example, a first communication field may be opened to transfer the payload, and second communication field may be opened to receive an account creation request.

Upon opening the communication field, in action 715 the mobile application can receive a payload from the contactless card. As a nonlimiting example, the user can place the contactless card within the communication field and transmit the payload. The payload can comprise encrypted user data. The user data can include user identification data including without limitation personal identifying information such as a name, email, phone number, address, and other identifying information. Furthermore, the encrypted user data can include without limitation contactless card information, account information, a unique customer identifier, a counter, and some combination thereof. The user data can be encrypted using a hash such as SHA-256 or any similar hash function. The encrypted nature of the user data coupled with the close proximity of the communication field improves the security of the transaction. Additionally, the payload can include one or more private keys necessary to decrypt the payload. Diversified key exchanges are discussed with further reference to FIG. 4.

In action 720, the payload can be decrypted. This action can be performed by the mobile application. In other embodiments, the mobile application can transmit the payload to a server where the payload can be decrypted. The payload can be decrypted by a private key sent along with the payload, or by some other shared key. In some embodiments, the mobile application or software application can transmit the decrypted payload or decrypted user identification data to a server, then the server can match the decrypted user identification data with a user account comprising at least checkout data, then the server can transmit the checkout data to the mobile application or software application.

In some embodiments, the checkout process associated with the consumer transaction requires the creation of a user account in action 725. The mobile application can receive an account creation request over a network. The request can be transmitted by a user device discussed with further reference to FIG. 1.

In response to the account creation request, in action 730 the mobile application can generate a user account. The mobile application can retrieve the necessary account information from a database, data storage unit, or server with the user data on file. The user data can comprise the information necessary to generate the account including without limitation personal information such as name and address, payment information such as contactless card information, and generate a random password.

Having generated the user account, the mobile application in action 735 can proceed with checkout or proceed with fulfilling the checkout information request. The checkout data can include without limitation a card number, a card verification value (CVV), and card expiration date. The data can further include without limitation a shipping address, name, and account number associated with the mobile application. This data can satisfy the checkout request or checkout information request from action 705.

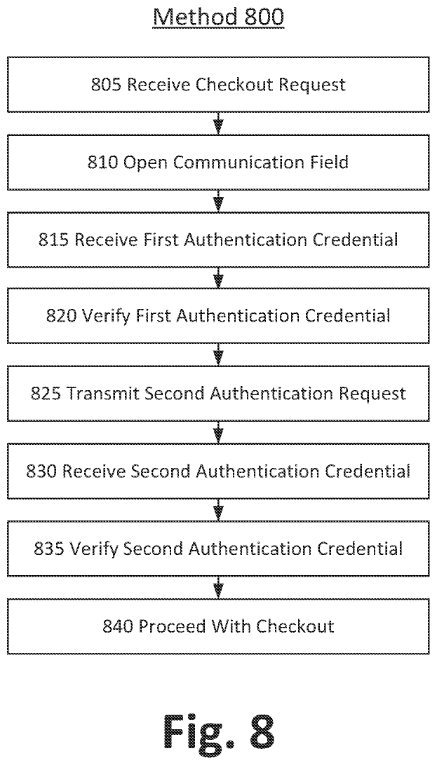

FIG. 8 is a method flowchart illustrating the method 800. In some embodiments, the mobile application can request a second authentication credential in addition to the payload discussed in FIGS. 6-7. This second authentication credential can improve the security of the checkout process and significantly reduce fraudulent purchases. In other embodiments, a web application can be used in place of a mobile application. In other embodiments, the software application is associated with a merchant mobile application or merchant software application configured to perform one or more mobile transactions. A merchant mobile application or merchant software application is a software application associated with one or more merchants and accessible through a computer-enabled device. A mobile transaction can include without limitation transaction of information from a mobile device to some other mobile device, computer-enabled device, or some other device.

In action 805, the mobile application can receive a checkout request or checkout information request. The mobile application can be associated with a merchant or other provider of a consumer product, service, or experience. The checkout request can be received by the mobile application from a server over a network. In other embodiments, the checkout request can be transmitted by the contactless card to the mobile application over a communication field, card reader, or wireless network. In other embodiments, the checkout request can be transmitted by user via the user device to the mobile application over a network. As a nonlimiting example, a user can transmit a checkout request to a mobile application at the conclusion of their shopping experience.

In action 810, the mobile application can open a communication field. Communication fields are discussed with further reference to FIG. 5. The communication field can be opened via a user device, including without limitation a computer-enabled mobile device, personal computer, and other devices discussed with reference to FIG. 1. The communication field comprises at least a near field communication (NFC) field, a Bluetooth field, or a radio-frequency identification (RFID) field. In other embodiments, more than one communication field may be opened.

Upon opening the communication field, in action 815 the mobile application can receive a payload from the contactless card. The payload can be the first authentication credential received by the mobile application. As a nonlimiting example, the user can place the contactless card within the communication field and transmit the payload. The payload can comprise encrypted user data. The user data can include user identification data including without limitation personal identifying information such as a name, email, phone number, address, and other identifying information. Furthermore, the encrypted user data can include without limitation contactless card information, account information, a unique customer identifier, a counter, and some combination thereof. The user data can be encrypted using a hash such as SHA-256 or any similar hash function. The encrypted nature of the user data coupled with the close proximity of the communication field improves the security of the transaction. Additionally, the payload can include one or more private keys necessary to decrypt the payload. Diversified key exchanges are discussed with further reference to FIG. 4.

In action 820, the payload can be decrypted. This action can be performed by the mobile application. In other embodiments, the mobile application can transmit the payload to a server where the payload can be decrypted. Upon decrypting the payload, the mobile application can match the user data with a user on file. In other embodiments, the mobile application can transmit the decrypted user data to a server wherein the server can match the user data to a user on file. This action verifies the first authentication credential. In some embodiments, the mobile application or software application can transmit the decrypted payload or decrypted user identification data to a server, then the server can match the decrypted user identification data with a user account comprising at least checkout data, then the server can transmit the checkout data to the mobile application or software application.

In action 825, the mobile application can transmit a second authentication request. In some embodiments, the second authentication request can be a short message service (SMS) containing a one-time password (OTP), a request for a biometric, a request for a password or personal identification number (PIN), or a request for an email verification. Biometrics can include without limitation facial scans, iris scans, fingerprint scans, a scalable ratio of facial features associated with the user, a face scan, hand scans, voice recognitions and voice scans, and handwriting recognitions. Biometrics can be transmitted from the user device to the mobile application over a network. The second authentication request can be sent over a network to a user device discussed with further reference to FIG. 1.

In action 830, the mobile application can receive the second authentication credential. The credential can be received over a network.

In action 835, the mobile application can verify the second authentication credential by matching the credential with a user on file. In some embodiments, the mobile application can send the credential to a server to verify the credential. The credential can be hashed or otherwise encrypted before transmitting it to the server. Upon verifying the credential, the mobile application can proceed with the checkout or checkout information request in action 840. The checkout data can include without limitation a card number, a card verification value (CVV), and card expiration date. The data can further include without limitation a shipping address, name, and account number associated with the mobile application. This data can satisfy the checkout request or checkout information request.

In some aspects, the techniques described herein relate to a system for securely fulfilling a checkout information request, the system including: a software application including instructions for execution on a user device, the software application configured to: receive, over a network, a checkout request; open, in response to receiving the checkout request, a communication field; receive a payload from a card via the communication field, the payload further including encrypted user identification data and a first authentication credential; decrypt the encrypted user identification data; match, upon decrypting the encrypted user identification data, the decrypted user identification data with a user account; and retrieve, upon matching the decrypted user identification data with the user account, checkout data, wherein the checkout data can satisfy the checkout request.

In some aspects, the techniques described herein relate to a system, wherein the first authentication credential includes a unique customer identifier associated with the card.

In some aspects, the techniques described herein relate to a system, wherein the user identification data includes a number associated with a user device.

In some aspects, the techniques described herein relate to a system, wherein the first authentication credential includes a one-time password (OTP).

In some aspects, the techniques described herein relate to a system, wherein the OTP is sent in the form of a short message service (SMS) to a mobile phone number associated with a user device.

In some aspects, the techniques described herein relate to a system, wherein the checkout data includes at least one selected from the group of an address associated with the user account, a phone number associated with the user account, and an email associated with the user account.

In some aspects, the techniques described herein relate to a system, wherein the checkout data includes at least one selected from the group of a card number, a card verification value (CVV), and a card expiration date associated with the card.

In some aspects, the techniques described herein relate to a system, wherein the checkout data is retrieved from a server.

In some aspects, the techniques described herein relate to a system, wherein the software application is associated with a merchant mobile application configured to perform one or more mobile transactions.

In some aspects, the techniques described herein relate to a system, wherein: the authentication credential is a message authentication code (MAC), the card has generated the MAC over a counter value, a unique customer identifier, and a session key, and the software application has decrypted the MAC by generating the private key over the unique customer identifier and a shared master key.

In some aspects, the techniques described herein relate to a system, wherein the software application is further configured to: receive an account creation request, the account creation request further including the checkout data; and generate, in response to receiving the account creation request, a second user account.

In some aspects, the techniques described herein relate to a method for securely fulfilling a checkout information request, the method including the steps of: receiving, over a network by a software application including instructions for execution on a user device, a checkout request; opening, by the software application in response to receiving the checkout request, a communication field; receiving, by a software application, a payload from a card, via the communication field, the payload further including encrypted user identification data and a first authentication credential; decrypting, by the software application, the encrypted user identification data; matching, by the software application upon decrypted the encrypted user identification data, the decrypted user identification data with a user account; and retrieving, by the software application upon matching the decrypted user identification data with the user account, checkout data, wherein the checkout data can satisfy the checkout request.

In some aspects, the techniques described herein relate to a method, wherein the steps further include: receiving, by the software application, an account creation request, the account creation request further including the checkout data; and generating, by the software application in response to receiving the account creation request, a second user account.

In some aspects, the techniques described herein relate to a method, wherein the card is a contactless payment card associated with a spending account.

In some aspects, the techniques described herein relate to a method, wherein the steps further include: transmitting, by the software application, the decrypted user identification data to a server; and receiving, by the software application, checkout data from the server wherein the server has matched the decrypted user identification data with a user account, the user account including at least the checkout data.

In some aspects, the techniques described herein relate to a method, wherein the steps further include: transmitting, by the software application a second authentication request to the user device; and receiving, by the software application from the user device in response to the second authentication request, a second authentication credential to the software application.

In some aspects, the techniques described herein relate to a method, wherein the second authentication credential is a biometric including at least a fingerprint, a face scan, or voice scan. In some aspects, the techniques described herein relate to a method, wherein the software application is a mobile application.

In some aspects, the techniques described herein relate to a method, wherein the communication field includes at least a near field communication (NFC) field, a Bluetooth field, or a radio-frequency identification (RFID) field.

In some aspects, the techniques described herein relate to a computer readable non-transitory medium including computer executable instructions that, when executed on a processor, configure the processor to perform procedures including the steps of: receiving a checkout request; opening, in response to receiving the checkout request, a communication field; receiving at least a payload from a card wherein the card has entered the communication field, the payload further including at least one or more encrypted user identification data and at least a first authentication credential; decrypting the encrypted user identification data; matching the decrypted user identification data with an existing user account; and retrieving, upon matching the decrypted user identification data with an existing user account, checkout data, wherein the checkout data can satisfy the checkout request.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the term “application” is understood to include any software application, including but not limited to a mobile application, web application, or other application. It is understood that any reference to a mobile application is not limiting, and that any reference to a mobile application also include any software application.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

What is claimed is:

1. A system for securely fulfilling a checkout information request, the system comprising:
a software application comprising instructions for execution on a user device, the software application configured to:
receive, over a network, a checkout request;
open, in response to receiving the checkout request, a communication field;
receive a payload from a card via the communication field, the payload further comprising encrypted user identification data and a first authentication credential;
decrypt the encrypted user identification data;
match, upon decrypting the encrypted user identification data, the decrypted user identification data with a user account; and
retrieve, upon matching the decrypted user identification data with the user account, checkout data, wherein the checkout data can satisfy the checkout request.

2. The system of claim 1, wherein the first authentication credential comprises a unique customer identifier associated with the card.

3. The system of claim 1, wherein the user identification data comprises a number associated with a user device.

4. The system of claim 1, wherein the first authentication credential comprises a one-time password (OTP).

5. The system of claim 4, wherein the OTP is sent in the form of a short message service (SMS) to a mobile phone number associated with a user device.

6. The system of claim 1, wherein the checkout data comprises at least one selected from the group of an address associated with the user account, a phone number associated with the user account, and an email associated with the user account.

7. The system of claim 1, wherein the checkout data comprises at least one selected from the group of a card number, a card verification value (CVV), and a card expiration date associated with the card.

8. The system of claim 1, wherein the checkout data is retrieved from a server.

9. The system of claim 1, wherein the software application is associated with a merchant mobile application configured to perform one or more mobile transactions.

10. The system of claim 1, wherein:
the authentication credential is a message authentication code (MAC),
the card has generated the MAC over a counter value, a unique customer identifier, and a session key, and
the software application has decrypted the MAC by generating a private key over the unique customer identifier and a shared master key.

11. The system of claim 1, wherein the software application is further configured to:
receive an account creation request, the account creation request further comprising the checkout data; and
generate, in response to receiving the account creation request, a second user account.

12. A method for securely fulfilling a checkout information request, the method comprising the steps of:
receiving, over a network by a software application comprising instructions for execution on a user device, a checkout request;
opening, by the software application in response to receiving the checkout request, a communication field;
receiving, by a software application, a payload from a card, via the communication field, the payload further comprising encrypted user identification data and a first authentication credential;
decrypting, by the software application, the encrypted user identification data;
matching, by the software application upon decrypted the encrypted user identification data, the decrypted user identification data with a user account; and
retrieving, by the software application upon matching the decrypted user identification data with the user account, checkout data, wherein the checkout data can satisfy the checkout request.

13. The method of claim 12, wherein the steps further comprise:
receiving, by the software application, an account creation request, the account creation request further comprising the checkout data; and
generating, by the software application in response to receiving the account creation request, a second user account.

14. The method of claim 12, wherein the card is a contactless payment card associated with a spending account.

15. The method of claim 12, wherein the steps further comprise:
transmitting, by the software application, the decrypted user identification data to a server; and
receiving, by the software application, checkout data from the server wherein the server has matched the decrypted user identification data with a user account, the user account comprising at least the checkout data.

16. The method of claim 12, wherein the steps further comprise:
transmitting, by the software application a second authentication request to the user device; and
receiving, by the software application from the user device in response to the second authentication request, a second authentication credential to the software application.

17. The method of claim 16, wherein the second authentication credential is a biometric comprising at least a fingerprint, a face scan, or voice scan.

18. The method of claim 17, wherein the software application is a mobile application.

19. The method of claim 12, wherein the communication field comprises at least a near field communication (NFC) field, a Bluetooth field, or a radio-frequency identification (RFID) field.

20. A computer readable non-transitory medium comprising computer executable instructions that, when executed on a processor, configure the processor to perform procedures comprising the steps of:
receiving a checkout request;
opening, in response to receiving the checkout request, a communication field;
receiving at least a payload from a card wherein the card has entered the communication field, the payload further comprising at least one or more encrypted user identification data and at least a first authentication credential;
decrypting the encrypted user identification data;
matching the decrypted user identification data with an existing user account; and
retrieving, upon matching the decrypted user identification data with an existing user account, checkout data, wherein the checkout data can satisfy the checkout request.
